(19) United States
(12) Patent Application Publication
(10) Pub. No.: US 2011/0129167 A1
(43) Pub. Date: Jun. 2, 2011

(54) IMAGE CORRECTION APPARATUS AND IMAGE CORRECTION METHOD

(75) Inventors: Yuri NOJIMA, Machida (JP); Masayoshi Shimizu, Kawasaki (JP)

(73) Assignee: FUJITSU LIMITED, Kawasaki (JP)

(21) Appl. No.: 12/954,218

(22) Filed: Nov. 24, 2010

Related U.S. Application Data
(63) Continuation of application No. PCT/JP2008/001476, filed on Jun. 10, 2008.

(51) Int. Cl. G06K 9/40

(52) U.S. Cl. 382/266

(57) ABSTRACT

An image correction apparatus includes a motion vector calculation unit, a characteristic decision unit and a correction unit. The motion vector calculation unit calculates a motion vector of an image based on a plurality of images sharing a shooting area. The characteristic decision unit decides an edge characteristic for image correction based on the motion vector calculated by the motion vector calculation unit. The correction unit corrects a pixel value of a pixel having the edge characteristic decided by the characteristic decision unit in an input image obtained from the plurality of images.

### CROSS-REFERENCE TO RELATED APPLICATIONS

This application is a continuation of an international application PCT/JP2008/001476, which was filed on Jun. 10, 2008, the entire contents of which are incorporated herein by reference.

### FIELD

The present invention relates to an image correction apparatus and an image correction method. The present invention is applicable to an image correction apparatus and an image correction method, which are intended to correct, for example, a blur of an image.

### BACKGROUND

For example, a method for sharpening an edge of an object or a texture within an image is known as a technique of correcting a hand tremor (a tremor caused by a move of a subject is not included here) of a shot image.

In normal cases, a pixel value (such as brightness, intensity, or the like) changes abruptly at an edge of an object or a texture within an image. A profile illustrated in FIG. 1 represents a change in a pixel value (brightness in this case) of an edge. A horizontal axis of the profile represents a position of a pixel. Since the brightness level ramps up and down at an edge, an area including the edge is sometimes referred to as a ramp area in this specification.

To sharpen an edge, for example, as illustrated in FIG. 1, a brightness level of each pixel is decreased in an area (area A) where the brightness level is lower than a central level, whereas the brightness level of each pixel is increased in an area (area B) where the brightness level is higher than the central level. Note that the brightness level is not corrected outside the ramp area. With such corrections, the width of the ramp area is narrowed to sharpen the edge. This method is disclosed, for example, by J.-G Leu, Edge sharpening through ramp width reduction, Image and Vision Computing 18 (2000) 501-514.

Additionally, an image processing method for correcting a blur in an image where only some of areas are blurred is proposed as a related technique. Namely, edge detection means detects an edge in eight different directions in a reduced image. Block partitioning means partitions the reduced image into 16 blocks. Analysis means determines whether or not an image of each of the blocks is a blurred image, and detects blur information (a blur width L, the degree of a blur, and a blur direction) of a block image that is a blurred image. Parameter setting means sets a correction parameter based on the blur information, and sets a correction intensity α according to the blur width L (For example, Japanese Laid-open Patent Publication No. 2005-332381).

However, with the method for removing a hand tremor within one image, an unsuitable correction is sometimes performed. For example, if an edge having a moderate gray level gradient is detected, procedures for determining that the moderate gradient has been caused by a hand tremor and for sharpening the edge are considered as one hand tremor correction method. With this method, however, also an edge having a moderate gray level gradient in an original image (an image shot without a hand tremor) is similarly corrected to a sharp edge. As a result, image quality is degraded in this case. Moreover, an unnecessary correction process is executed, leading to the possibility of increasing a processing time and/or power consumption.

### SUMMARY

According to an aspect of the invention, an image correction apparatus includes: a motion vector calculation unit to calculate a motion vector of an image based on a plurality of images sharing a shooting area; a characteristic decision unit to decide an edge characteristic for image correction based on the motion vector calculated by the motion vector calculation unit; and a correction unit to correct a pixel value of a pixel having the edge characteristic decided by the characteristic decision unit in an input image obtained from the plurality of images.

According to another aspect of the invention, an image correction method includes: calculating a motion vector of an image based on a plurality of image sharing a shooting area; deciding an edge characteristic for image correction based on the calculated motion vector; and correcting a pixel value of a pixel having the decided edge characteristic in an input image obtained from the plurality of images.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view of a method for sharpening an edge;

FIG. 2 illustrates a configuration of an image correction apparatus according to an embodiment;

FIG. 3 is a flowchart illustrating an image correction method according to the embodiment;

FIG. 4 is an explanatory view of a motion vector;

FIG. 5 illustrates a direction defined within an image;

FIG. 6 is an explanatory view of one example of a method for deciding an edge to be corrected;

FIG. 7 is an explanatory view of an implementation example of the method for deciding an edge to be corrected;

FIG. 8 illustrates a hardware configuration related to the image correction apparatus according to the embodiment;

FIG. 9 illustrates a configuration of a blur correction circuit;

FIGS. 10A and 10B illustrate implementation examples of a smoothing filter;

FIG. 11 is a flowchart illustrating operations of a blur correction apparatus;

FIGS. 12A and 12B illustrate configurations of a Sobel filters;

FIGS. 13 to 15 illustrate filters for calculating a pixel intensity index;

FIGS. 16 and 17 illustrate filters for calculating a gradient index.

### DESCRIPTION OF EMBODIMENTS

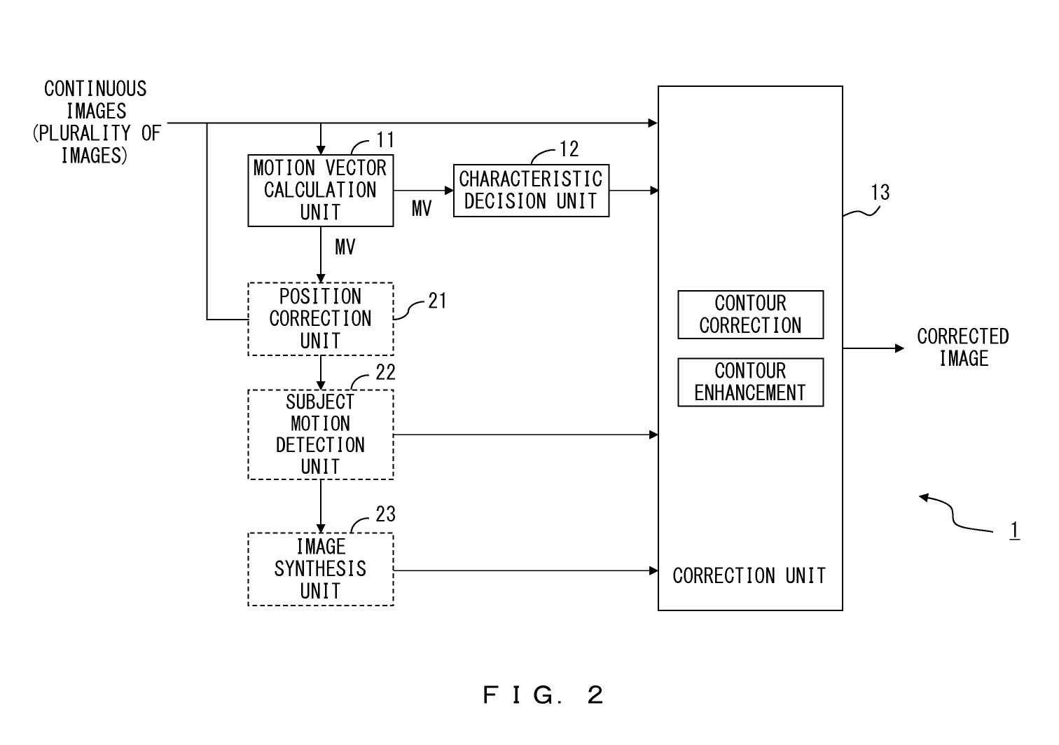

FIG. 2 illustrates a configuration of an image correction apparatus according to an embodiment. The image correction apparatus 1 according to the embodiment corrects, for example, an image obtained with an electronic camera although the apparatus is not particularly limited. Moreover, the image correction apparatus 1 is assumed to correct a hand tremor. A hand tremor is caused, for example, by a move of a shooting device when an image is shot. Image degradation caused by a hand tremor mainly occurs in an edge of an object or a texture within an image. Accordingly, the image correction apparatus 1 corrects a hand tremor by sharpening an edge and/or by enhancing a contour.

Input of the image correction apparatus 1 is a plurality of images sharing a shooting area. The plurality of images is assumed to be images continuously shot one after another in a short time.

The image correction apparatus 1 includes a motion vector calculation unit 11, a characteristic decision unit 12, and a correction unit 13. The motion vector calculation unit calculates a motion vector of an image based on the continuously-shot images. The characteristic decision unit 12 decides an edge characteristic, to which an image correction is to be performed, based on the calculated motion vector. The correction unit 13 corrects a pixel value of a pixel having an edge characteristic in an image to be corrected, which is obtained from the continuously-shot images. The image to be corrected is, for example, an arbitrary one of continuously-shot images. Alternatively, the image to be corrected may be a synthesized image obtained by synthesizing a plurality of images. Note that the correction unit 13 performs, for example, a contour correction for sharpening an edge, and/or contour enhancement.

As described above, the image correction apparatus 1 according to the embodiment does not correct all pixels but only a particular pixel decided according to a motion vector. Accordingly, the amount of computation for the image correction is reduced, leading to a decrease in power consumption.

The image correction apparatus 1 may further include a position correction unit 21, a subject motion detection unit 22, and an image synthesis unit 23. The position correction unit 21 corrects a positional displacement among a plurality of images. The subject motion detection unit 22 detects a motion of a subject by using the plurality of images the positional displacement of which has been corrected. The “motion of the subject” is detected, for example, when a person is waving, or when a automobile is running. The image synthesis unit 23 generates a synthesized image by synthesizing a plurality of images the positional displacement of which has been corrected by the position correction unit 21. At this time, the image synthesis unit 23 may synthesize images of areas where a motion of a subject is not detected. In this case, the image synthesis unit 23 does not synthesize images of areas where a motion of a subject is detected.

When a synthesized image is generated in this way, the correction unit 13 corrects a pixel value of a pixel having the above described edge characteristic in the synthesized image. When the synthesized image is used, noise of the image given to the correction unit 13 is removed, and a lack of a light quantity is prevented, thereby improving image quality.

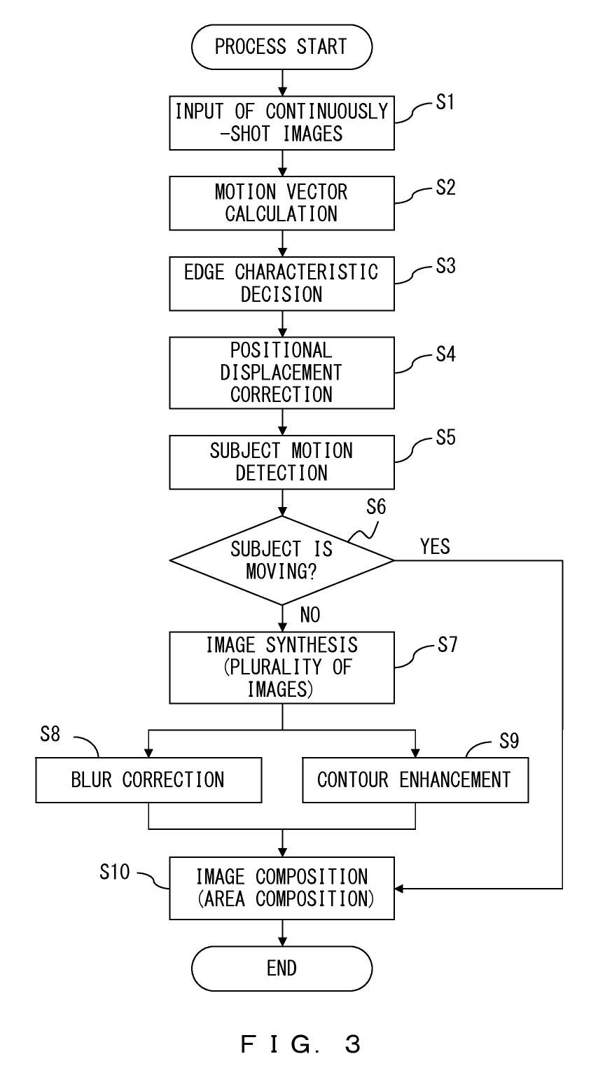

FIG. 3 is a flowchart illustrating an image correction method according to the embodiment. A process of this flowchart is assumed to be executed when images are continuously shot. The number of continuously-shot images is not particularly limited.

In step S1, continuously-shot images (a plurality of images sharing a shooting area) are input to the image correction apparatus 1. In step S2, the motion vector calculation unit 11 calculates a motion vector based on the continuously-shot images. The motion vector calculated here represents an image blur caused by a hand tremor. The motion vector is calculated, for example, by extracting a feature point with the use of a KLT transform and by tracking the feature point although the way of calculating the motion vector is not particularly limited. The KLT transform is referred to, for example, in the following documents.
(1) Bruce D. Lucas and Takeo Kanade. An Iterative Image Registration Technique with an Application to Stereo Vision. International Joint Conference on Artificial Intelligence, pages 674-679, 1981.
(2) Carlo Tomasi and Takeo Kanade. Detection and Tracking of Point Features. Carnegie Mellon University Technical Report CMU-CS-91-132, April 1991.
(3) Jianbo Shi and Carlo Tomasi. Good Features to Track. IEEE Conference on Computer Vision and Pattern Recognition, pages 593-600, 1994.

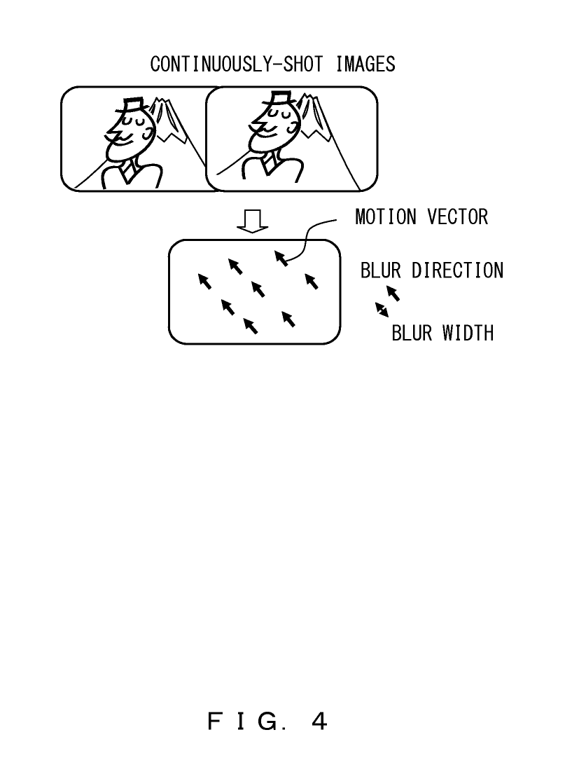

FIG. 4 is an explanatory view of a motion vector. Here, the motion vectors when a camera is moved by a hand tremor in a certain direction at the time of shooting is depicted. In this case, the motion vectors are represented with the amount of a move in X direction and that in Y direction, and the motion vectors are substantially the same at all positions within the image. The direction of the motion vector represents a blur direction, and the magnitude of the motion vector represents the amount of a blur. When the camera rotates at the time of shooting, 3×3 matrix that represents the rotation is calculated.

In step S3, the characteristic decision unit 12 decides an edge characteristic, to which an image correction is to be performed (or a condition of a pixel to which an image correction is to be performed), based on the calculated motion vector. The edge characteristic is decided, for example, based on a blur direction (the direction of a motion vector). In this case, the edge characteristic is defined, for example, with a pixel value gradient direction of each pixel. The pixel value, not particularly limited, is, for example, a brightness level. The edge characteristic may be decided based on the amount of a blur (the magnitude of a motion vector).

Assume that components of a calculated motion vector are X=−1 and Y=2. In this case, a blur direction is calculated with the following equation.

Blur direction=arctan(amount of a move in Y direction/amount of a move in X direction)=arctan(−2)=−1.107

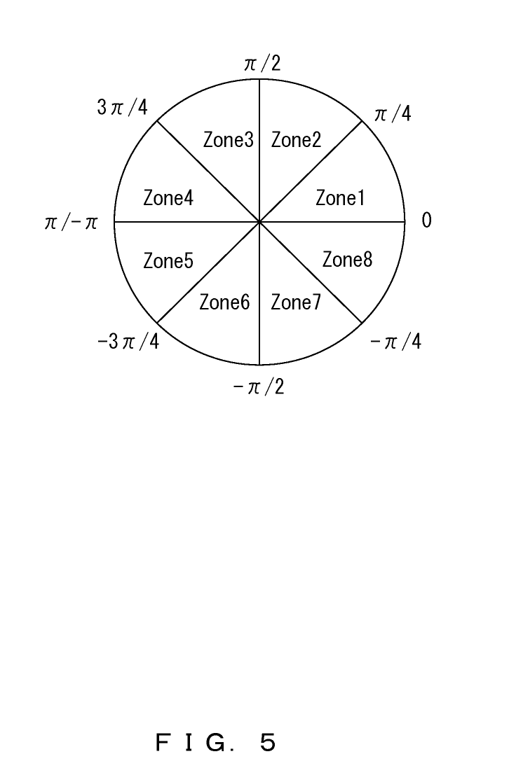

In this case, the blur direction belongs to Zone 3 among Zone 1 to Zone 8 illustrated in FIG. 5. π/4 is respectively assigned to each Zone.

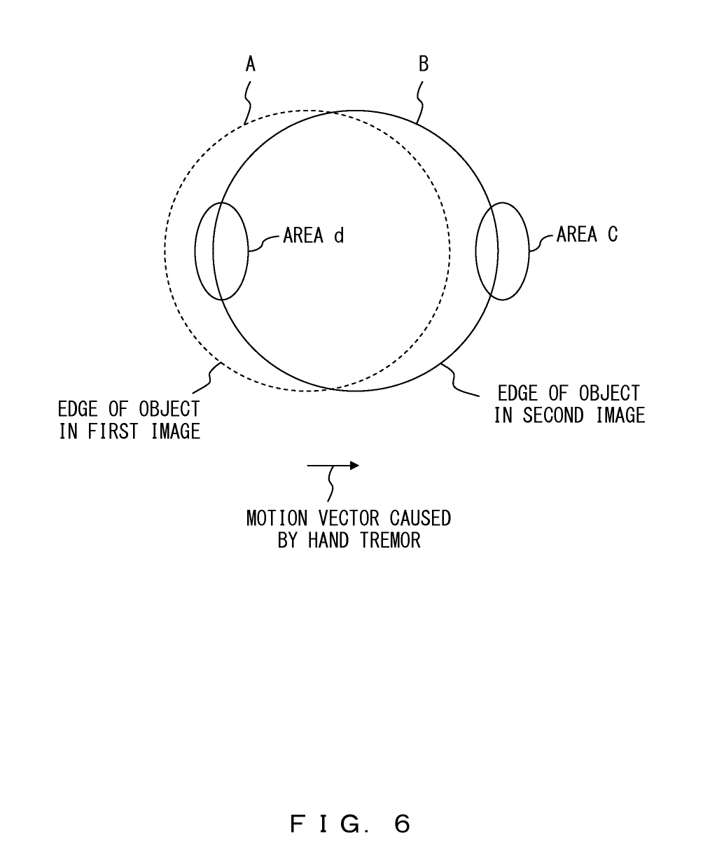

FIG. 6 is an explanatory view of a method for deciding an edge to be corrected. Here, assume that a subject is moved by a hand tremor from a position A to a position B between two continuous images. In this case, edges of the subject are mainly blurred in areas c and d. Namely, the edges belonging to the areas c and d need to be corrected, but edges in other areas do not need to be corrected. Accordingly, with the image correction method according to the embodiment, only the edges belonging to the areas c and d are detected and corrected. As a result, the amount of computation for the image correction is reduced.

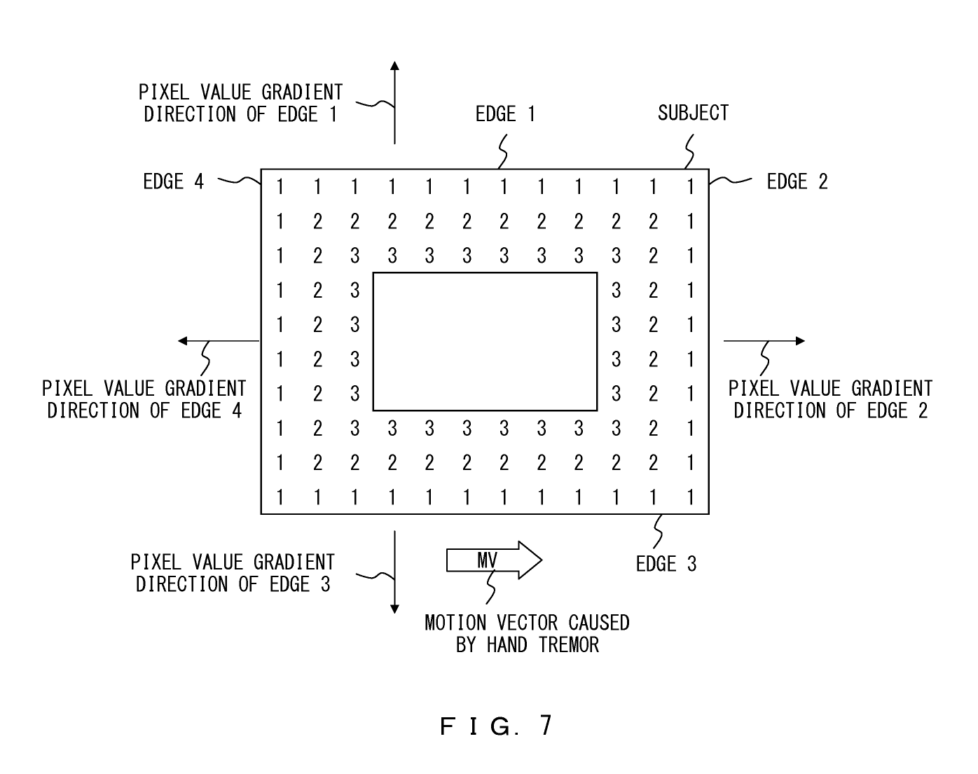

FIG. 7 is an explanatory view of an implementation example of the method for deciding an edge to be corrected. Here, assume that a contour of a subject is formed by edges 1 to 4. Moreover, each of the edges of the subject has a gradient of a pixel value (such as a brightness level) varying from “3” to “1” toward the outside of the subject. In this implementation example, the direction where the pixel value decreases is referred to as “pixel value gradient direction”.

In the example illustrated in FIG. 7, the direction of a motion vector MV caused by a hand tremor is parallel to pixel value gradient directions of the edge 2 and the edge 4. In this case, the edge 2 and the edge 4 are blurred by the hand tremor. Accordingly, a hand tremor correction needs to be performed for the edge 2 and the edge 4. In contrast, pixel value gradient directions of the edge 1 and the edge 3 are orthogonal to the direction of the motion vector MV. In this case, the edge 1 and the edge 3 are not significantly blurred by the hand tremor in this case. Namely, the hand tremor correction does not need to be performed for the edge 1 and the edge 3.

Accordingly, with the image correction method according to the embodiment, a pixel value of a pixel having a pixel value gradient direction that has a certain relationship with the direction of a motion vector is corrected. Specifically, the correction process is executed for a pixel having a pixel value gradient direction that is almost the same as a motion vector, and a pixel having a pixel value gradient direction that is almost reverse to the motion vector. For example, if the direction of the motion vector caused by the hand tremor belongs to Zone 3 illustrated in FIG. 5, the correction process is executed for a pixel having a pixel value gradient direction that belongs to Zone 3 or Zone 7.

Referring back to FIG. 3. In step S4, the position correction unit 21 corrects a positional displacement among the plurality of images based on the calculated motion vector. When two images are input to the image correction apparatus, for example, positions of pixels of one image are corrected according to the motion vector with respect to the other image. Alternatively, when three images are input to the image correction apparatus, for example, positions of pixels of the first and the third images are corrected according to the motion vector with respect to the second image. As a result of executing step S4, the plurality of images the positional displacement of which has been corrected are obtained.

In steps S5 and S6, the subject motion detection unit 22 detects a motion of the subject by using the plurality of images the positional displacement of which has been corrected. The motion of the subject (such as a state where a person as the subject is waving, a state where an automobile as the subject is running, or the like) is detected, for example, by calculating a difference among the plurality of images the positional displacement of which has been corrected, although the detection method is not particularly limited. In this detection method, if the difference is zero (or a sufficiently small value), it is determined that the subject is not moving. If the difference is larger than a predetermined value, it is determined that the subject is moving. As a result, pixels of the moving subject are detected.

In step S7, the image synthesis unit 23 synthesizes images of areas where the subject is not moving. Namely, pixel data of pixels at identical positions of the plurality of images in the area where the subject is not moving are synthesized. As a result, the synthesized image of the areas where the subject is not moving is generated.

In step S8, the correction unit 13 performs blur correction for the synthesized image. The blur correction is, for example, a contour correction or edge sharpening. In step S9, the correction unit 13 performs contour enhancement for the synthesized image. Note that the correction unit 13 may perform either or both of steps S8 and S9. When both of steps S8 and S9 are executed, their order is not particularly limited.

The corrections of steps S8 and/or S9 are performed for each of the pixels. However, these corrections do not need to be performed for all the pixels. Namely, as referred to in step S3, the corrections are performed only for particular pixels decided according to the motion vector. Implementation examples of steps S8 and S9 will be described later.

In step S10, the image of the areas corrected in steps S8 and/or S9, and an image of an area where the subject is not moving are composited. As a result, a corrected image is obtained.

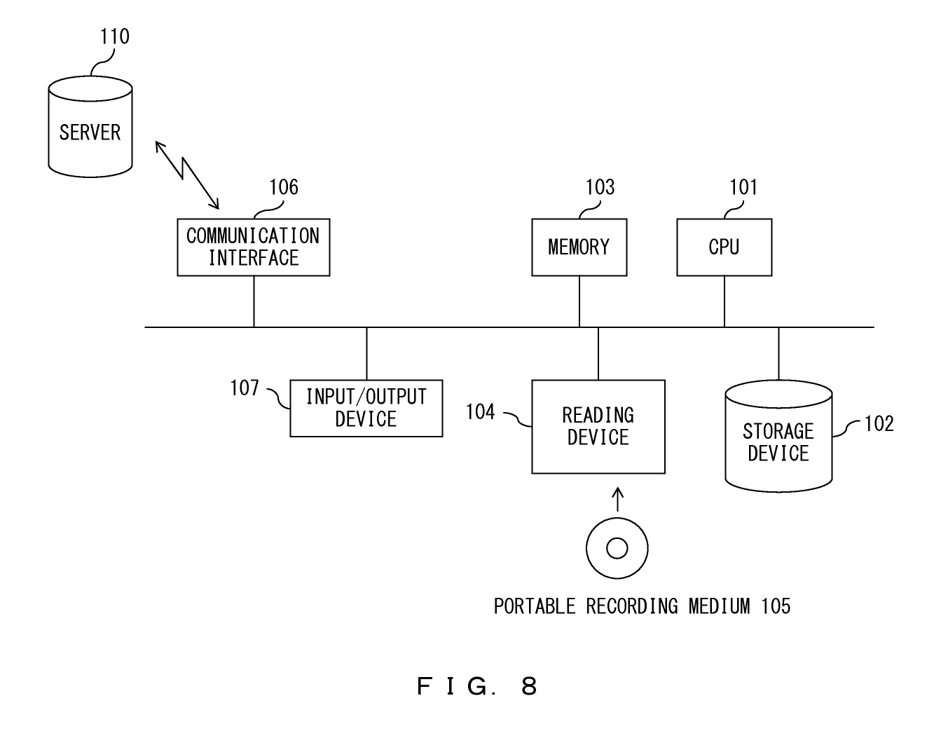

FIG. 8 illustrates a hardware configuration related to the image correction apparatus 1 according to the embodiment. In FIG. 6, a CPU 101 executes an image correction program by using a memory 103. A storage device 102 is, for example, a hard disk, and stores the image correction program. The storage device 102 may be an external recording device. The memory 103 is, for example, a semiconductor memory. The memory 103 may be configured to include RAM area and ROM area.

A reading device 104 accesses a portable recording medium 105 according to an instruction from the CPU 101. Examples of the portable recording medium 105 include a semiconductor device (PC card or the like), a medium to/from which information is input/output with a magnetic action, and a medium to/from which information is input/output with an optical action. A communication interface 106 transmits and receives data via a network according to an instruction from the CPU 101. An input/output device 107 corresponds to devices such as a camera, a display device, and a device that accepts an instruction from a user.

The image correction program according to this embodiment is provided, for example, in one of the following ways.

(1) Preinstalled in the storage device 102
(2) Provided by the portable recording medium 105
(3) Downloaded from a program server 110

The computer configured as described above executes the image correction program, whereby the image correction apparatus according to the embodiment is implemented.

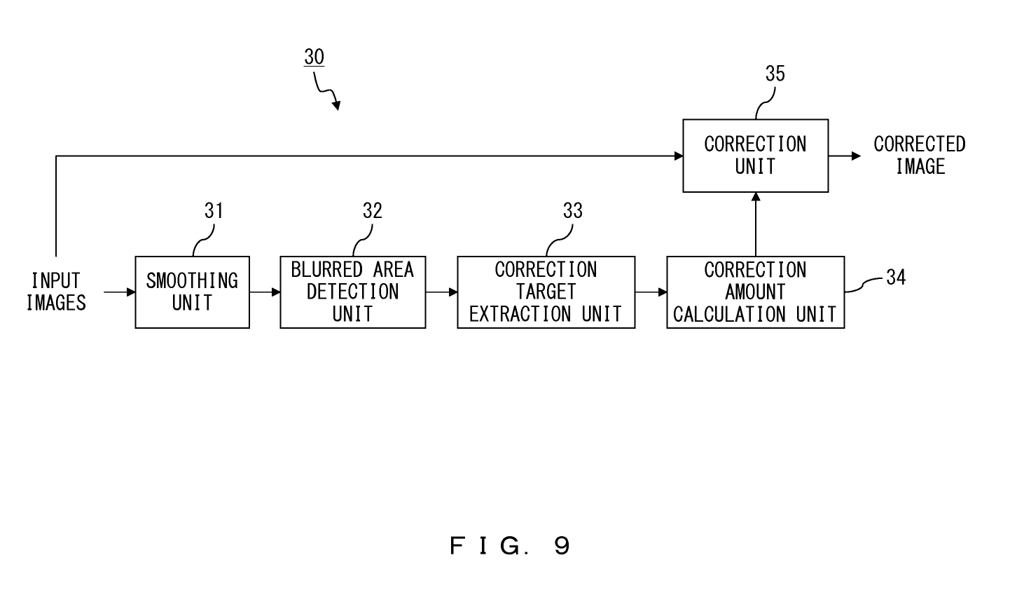

FIG. 9 illustrates a configuration of a blur correction circuit 30 for executing the blur correction process of step S8 illustrated in FIG. 3. An input image of the blur correction circuit 30 is an image of areas where a subject is not moving as described with reference to FIG. 3. Alternatively, the input image of the blur correction circuit 30 may be an arbitrary one of continuously-shot images (one of a plurality of images).

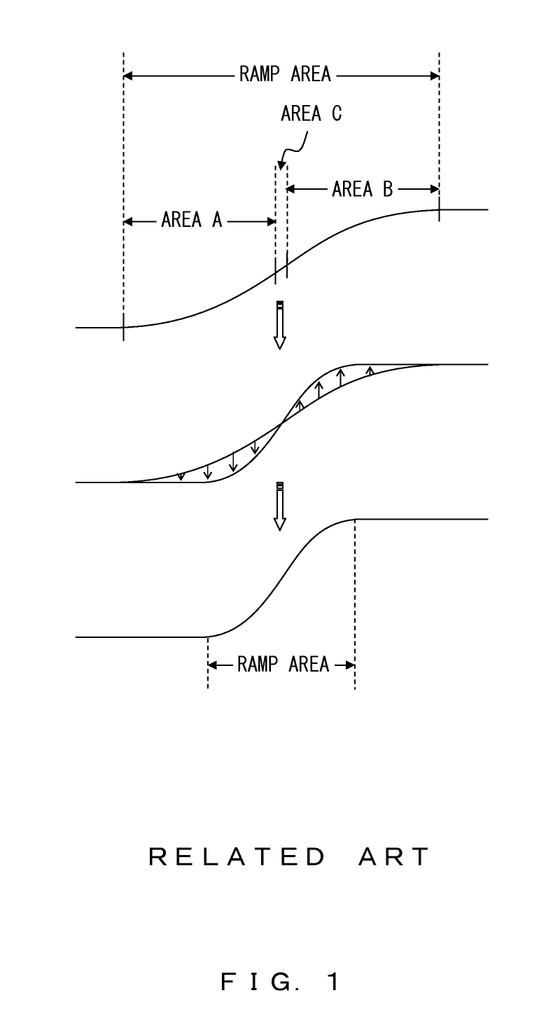

The input image is provided to a smoothing unit 31 and a correction unit 35. The smoothing unit 31 is, for example, a smoothing (or averaging) filter, and smoothes brightness values of pixels of the input image. With the smoothing process, noise in the input image is removed (or reduced). A blurred area detection unit 32 detects an area where a hand tremor is supposed to occur in a smoothed image output from the smoothing unit 31. Namely, the blurred area detection unit 32 estimates, for each of the pixels of the smoothed image, whether or not a hand tremor has occurred. Image degradation caused by a hand tremor mainly occurs in an edge of an object or a texture within an image, as described above. Moreover, a brightness level is normally inclined in an edge area, as illustrated in FIG. 1. Accordingly, the blurred area detection unit 32 detects a hand tremor area, for example, by detecting an inclination of brightness level in a smoothed image.

A correction target extraction unit 33 extracts a pixel to be corrected in the detected blurred area (hand tremor area). A condition or rule for extracting a pixel to be corrected is decided based on a motion vector in step S3 illustrated in FIG. 3. For example, if the direction of the motion vector belongs to Zone 3 illustrated in FIG. 5, a pixel having a pixel value gradient direction (here, a brightness inclination direction) that belongs Zone 3 or Zone 7 is extracted.

A correction amount calculation unit 34 calculates the amount of a correction for the pixel extracted by the correction target extraction unit 33. The correction unit 35 corrects the input image by using the amount of a correction calculated by the correction amount calculation unit 34. At this time, the correction unit 35, for example, increases a brightness value of a pixel having a brightness level higher than a central level, and decreases a brightness value of a pixel having a brightness level lower than the central level in an edge area as described with reference to FIG. 1. As a result, the edge becomes sharp.

As described above, the blur correction circuit 30 extracts a pixel to be corrected according to a condition decided based on a motion vector, and calculates the amount of a correction for the extracted pixel. At this time, noise has been removed (or reduced) in a smoothed image. Accordingly, a detected blurred area and a calculated amount of a correction are not affected by noise. Therefore, an edge within an image is sharpened without being affected by noise.

The smoothing unit 31 detects the size of the input image. Namely, for example, the number of pixels of the input image is detected. A method for detecting an image size is not particularly limited, and may be implemented with a known technique. For example, if the size of the input image is smaller than a threshold value, 3×3 filter is selected. If the size of the input image is larger than the threshold value, 5×5 filter is selected. The threshold value, not particularly limited, is, for example, 1M pixels.

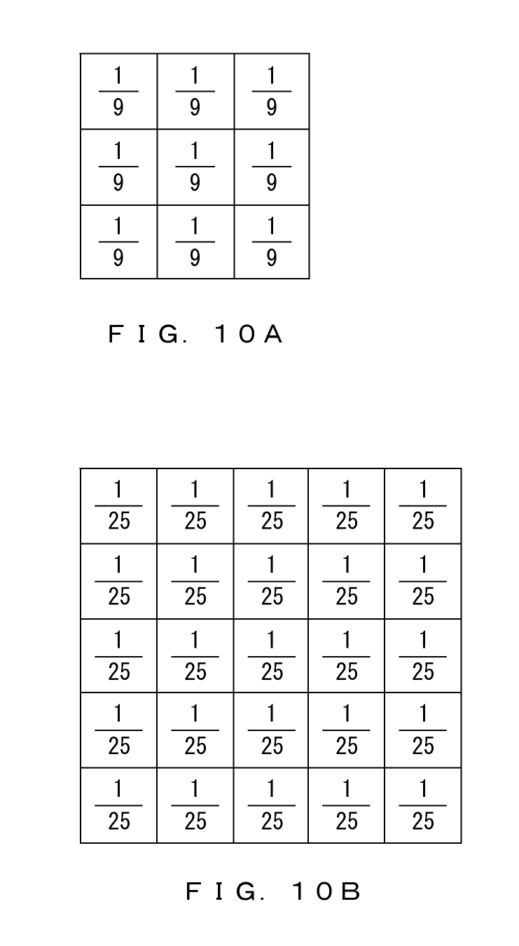

FIG. 10A illustrates an implementation example of the 3×3 filter. The 3×3 filter performs a smoothing operation for each pixel of an input image. Namely, an average of brightness values of a target pixel and eight pixels adjacent to the target pixel (a total of nine pixels) is calculated.

FIG. 10B illustrates an implementation example of the 5×5 filter. Similarly to the 3×3 filter, the 5×5 filter performs a smoothing operation for each pixel of an input image. However, the 5×5 filter calculates an average of brightness values of a target pixel and 24 pixels adjacent to the target pixel (a total of 25 pixels).

As described above, the smoothing unit 31 smoothes an input image by using the filter selected according to the size of an image. Here, noise normally increases in an image of a larger size. Accordingly, a stronger smoothing process is needed as an image size increases.

In the above described embodiment, either of the two types of filters is selected. However, the image correction apparatus according to the embodiment is not limited to this configuration. Namely, one filter may be selected from among three or more types of filters according to the size of an image. Moreover, FIG. 10A and FIG. 10B respectively illustrate the filters for calculating a simple average of a plurality of pixel values. However, the image correction apparatus according to the embodiment is not limited to this configuration. Namely, a weighted average filter having, for example, a larger weight at a center or in a central area may be used as a filter of the smoothing unit 31.

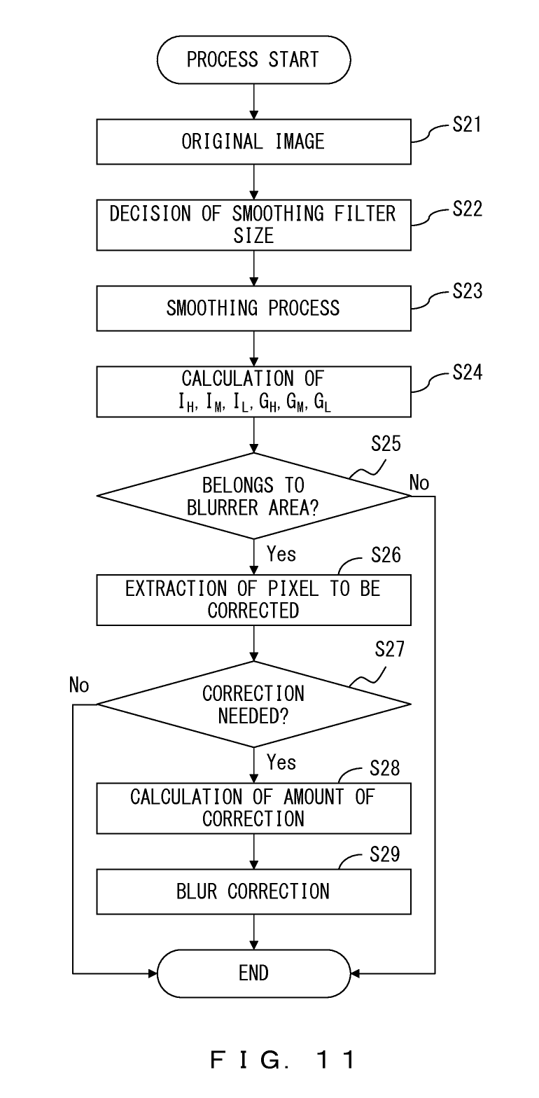

FIG. 11 is a flowchart illustrating operations of the blur correction circuit 30. In FIG. 11, image data is input in step S21. The image data includes pixel values (such as brightness information and the like) of pixels. In step S22, the size of a smoothing filter is determined. The size of the smoothing filter is determined according to the size of the input image as described above. In step S23, the input image is smoothed by using the filter determined in step S22.

In step S24, evaluation indexes I_{H}, I_{M}, I_{L}, G_{H}, G_{M} and G_{L}, which will be described later, are calculated for each of the pixels of the smoothed image. In step S25, whether or not each of the pixels of the smoothed image belongs to a blurred area is determined by using the evaluation indexes I_{H}, I_{M} and I_{L}. In step S26, a pixel to be corrected is extracted. Steps S27 to S29 are executed for the pixel to be corrected. In the meantime, for pixels that are not extracted in step 26, the processes of steps S27 to S29 are skipped.

In step S27, whether or not to correct the brightness value of the target pixel is determined by using the evaluation indexes G_{H}, G_{M} and G_{L} for the target pixel. If the brightness value of the target pixel is determined to be corrected, the amount of a correction is calculated by using the evaluation indexes I_{H}, I_{M}, I_{L}, G_{H}, G_{M} and G_{L} in step S28. Then, in step S29, the input image is corrected according to the calculated amount of a correction.

The processes in steps S22 and S23 are executed by the smoothing unit 31 illustrated in FIG. 9. Steps S24 to S29 correspond to a process for sharpening an edge by narrowing the width of a ramp area (an area where brightness level is inclined) of the edge. Processes of steps S24 to S29 are described below.

Calculation of the Evaluation Indexes (Step S24)

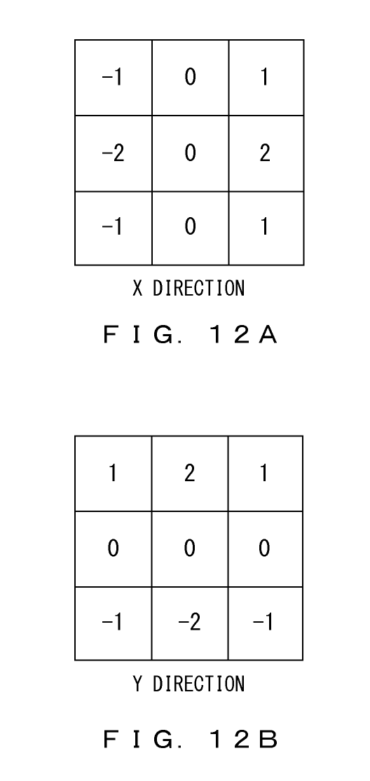

Sobel operations are performed for each of the pixels of the smoothed image. For the Sobel operations, Sobel filters, illustrated in FIGS. 12A and 12B, are used. In the Sobel operations, a target pixel and eight pixels adjacent to the target pixel are used. FIG. 12A illustrates a configuration of a Sobel filter in X direction, whereas FIG. 12B illustrates a configuration of a Sobel filter in Y direction. A Sobel operation in the X direction and a Sobel operation in the Y direction are performed for each of the pixels. Results of the Sobel operations in the X direction and the Y direction are hereinafter referred to as “gradX” and “gradY”, respectively.

The magnitude of a gradient of brightness is calculated for each of the pixels by using the results of the Sobel operations. The magnitude “gradMag” of the gradient is calculated, for example, with the following equation (1).

gradMag=\sqrt{gradX²+gradY²} (1)

Alternatively, the gradient may be calculated with the following equation (2) in order to reduce the amount of computation.

gradMag=|gradX|+|gradY| (2)

Then, a direction of the gradient is obtained for each of the pixels by using the results of the Sobel operations. The direction “PixDirection (θ)” of the gradient is obtained with the following equation (3). If “gradX” is close to zero (for example, gradX<10⁶), PixDirection=−π/2 is assumed.

$$PixDirection ( θ ) = arctan ( \frac{gradY}{gradX} ) \qquad ( 3 )$$

Next, it is determined, for each of the pixels, which of Zone 1 to Zone 8 illustrated in FIG. 5 the direction of the gradient belongs to. Zone 1 to Zone 8 are as follows.

Zone1: 0≦PixDirection<π/4 and gradX>0

Zone2: π/4≦PixDirection<π/2 and gradY>0

Zone3: −π/2≦PixDirection<−π/4 and gradY<0

Zone4: −π/4≦PixDirection<0 and gradX<0

Zone5: 0≦PixDirection<π/4 and gradX<0

Zone6: π/4≦PixDirection<π/2 and gradY<0

Zone7: −π/2≦PixDirection<−π/4 and gradY>0

Zone8: −π/4≦PixDirection<0 and gradX>0

Then, the pixel intensity indexes I_{H}, I_{M} and I_{L} are calculated for each of the pixels of the smoothed image. The pixel intensity indexes I_{H}, I_{M} and I_{L} depend on the direction of the gradient obtained with the above equation (3). An example of calculating the pixel intensity indexes I_{H}, I_{M} and I_{L} when the direction of the gradient belongs to Zone 1 (0≦θ<π/4) is described as an implementation example. The direction of the gradient of a pixel (i, j) is hereinafter referred to as “θ(i, j)”.

Initially, the following equations are defined for “θ=0”. “P(i, j)” represents a brightness value of a pixel positioned at coordinates (i, j). “P(i,j+1)” represents a brightness value of a pixel positioned at coordinates (i,j+1). The similar expressions are applied to the other pixels.

I_{H}(0)=0.25×{P(i+1,j+1)+2×P(i,j+1)+P(i−1,j+1)}

I_{M}(0)=0.25×{P(i+1,j)+2×P(i,j)+P(i−1,j)}

I_{L}(0)=0.25×{P(i+1,j−1)+2×P(i,j−1)+P(i−1,j−1)}

Similarly, the following equations are defined for “θ=π/4”.

I_{H}(π/4)=0.5×{P(i+1,j)+P(i,j+1)}

I_{M}(π/4)=0.25×{P(i+1,j−1)+2×P(i,j)+P(i−1,j+1)}

I_{L}(π/4)=0.5×{P(i,j−1)+P(i−1,j)}

Here, the three pixel intensity indexes of Zone 1 are calculated with linear interpolation using the pixel intensity indexes of “θ=0” and those of “θ=π/4”. Namely, the three pixel intensity indexes of Zone 1 are calculated with the following equations.

I_{H,Zone1}=I_{H}(0)×ω+I_{H}(π/4)×(1−ω)

I_{M,Zone1}=I_{M}(0)×ω+I_{M}(π/4)×(1−ω)

I_{L,Zone1}=I_{L}(0)×ω+I_{L}(π/4)×(1−ω)

ω=1−{4×θ(i,j)}/π

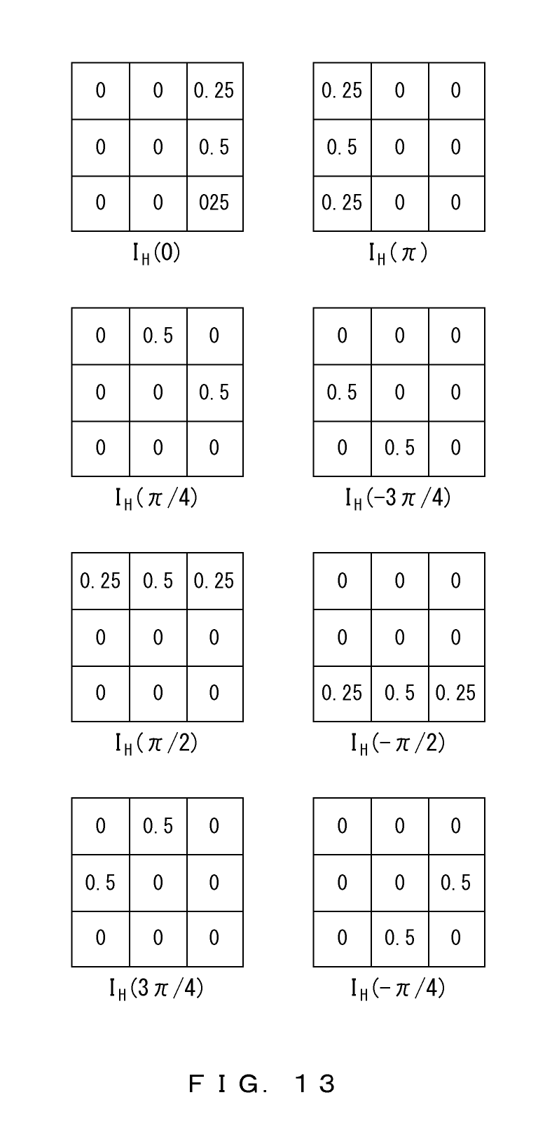

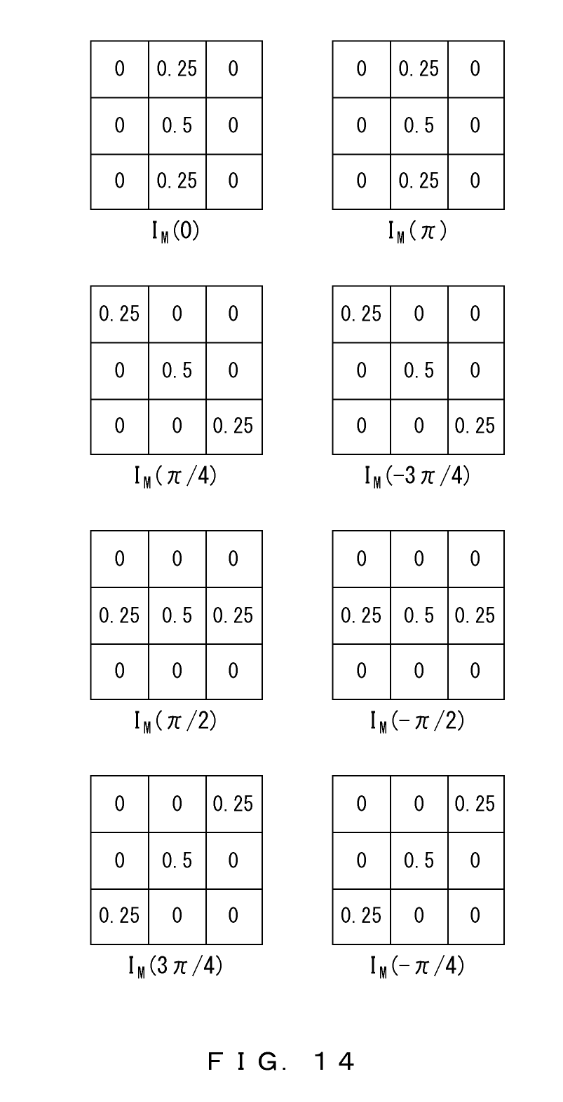

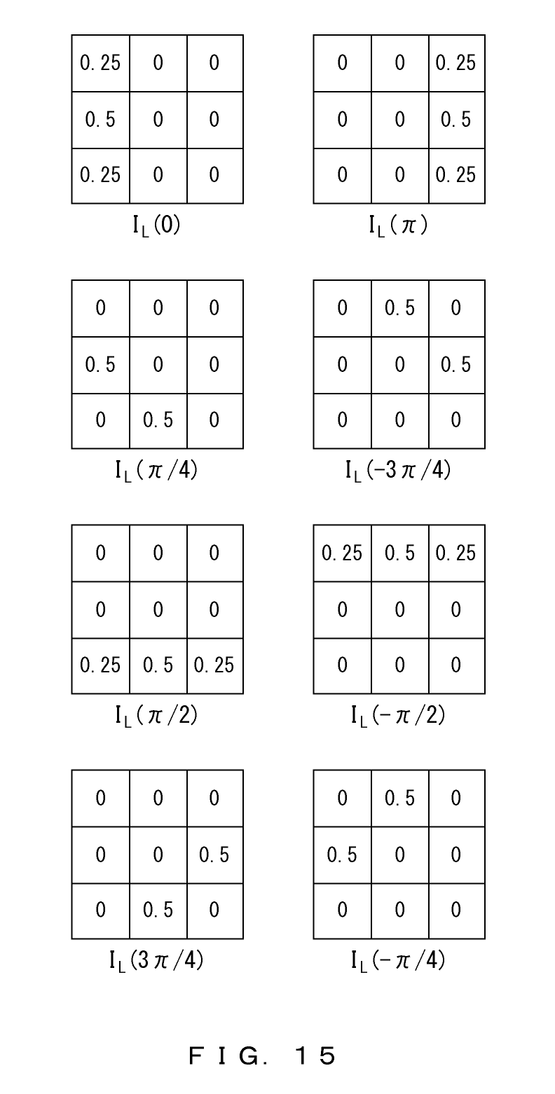

Also the pixel intensity indexes of Zone 2 to Zone 8 are calculated with similar procedures. Namely, the pixel intensity indexes are respectively calculated for “θ=0, π/4, π/2, 3π/4, π, −3π/4, −π/2, and −π/4”. These pixel intensity indexes are respectively obtained by performing 3×3 filter computation for the brightness value of each of the pixels of the smoothed image. FIGS. 13, 14 and 15 illustrate configurations of filters for respectively obtaining the pixel intensity indexes I_{H}, I_{M} and I_{L}.

By using these filters, the pixel intensity indexes I_{H}, I_{M} and I_{L} in the eight directions are calculated. The pixel intensity indexes I_{H} of the Zones are respectively calculated with the following equations by using the pixel intensity indexes I_{H} in two corresponding directions.

I_{H,Zone1}=I_{H}(0)×w15+I_{H}(π/4)×(1−w15)

I_{H,Zone2}=I_{H}(π/2)×w26+I_{H}(π/4)×(1−w26)

I_{H,Zone3}=I_{H}(π/2)×w37+I_{H}(3π/4)×(1−w37)

I_{H,Zone4}=I_{H}(π)×w48+I_{H}(3π/4)×(1−w48)

I_{H,Zone5}=I_{H}(π)×w15+I_{H}(−3π/4)×(1−w15)

I_{H,Zone6}=I_{H}(−π/2)×w26+I_{H}(−3π/4)×(1−w26)

I_{H,Zone7}=I_{H}(−π/2)×w37+I_{H}(−π/4)×(1−w37)

I_{H,Zone8}=I_{H}(0)×w48+I_{H}(−π/4)×(1−w48)

where w15, w26, w37 and w48 are respectively represented with the following equations.

W15=1−4θ/π

W26=4θ/π−1

W37=−1−4θ/π

W48=1+4θ/π

Additionally, the pixel intensity indexes I_{M} of the Zones are respectively calculated with the following equations by using the pixel intensity indexes I_{M} in two corresponding directions.

I_{M,Zone1}=I_{M}(0)×w15+I_{M}(π/4)×(1−w15)

I_{M,Zone2}=I_{M}(π/2)×w26+I_{M}(π/4)×(1−w26)

I_{M,Zone3}=I_{M}(π/2)×w37+I_{M}(3π/4)×(1−w37)

I_{M,Zone4}=I_{M}(π)×w48+I_{M}(3π/4)×(1−w48)

I_{M,Zone5}=I_{M}(π)×w15+I_{M}(−3π/4)×(1−w15)

I_{M,Zone6}=I_{M}(−π/2)×w26+I_{M}(−3π/4)×(1−w26)

I_{M,Zone7}=I_{M}(−π/2)×w37+I_{M}(−π/4)×(1−w37)

I_{M,Zone8}=I_{M}(0)×w48+I_{M}(−π/4)×(1−w48)

Similarly, the pixel intensity indexes I_{L} of the Zones are respectively calculated with the following equations by using the pixel intensity indexes I_{L} in two corresponding directions.

I_{L,Zone1}=I_{L}(0)×w15+I_{L}(π/4)×(1−w15)

I_{L,Zone2}=I_{L}(π/2)×w26+I_{L}(π/4)×(1−w26)

I_{L,Zone3}=I_{L}(π/2)×w37+I_{L}(3π/4)×(1−w37)

I_{L,Zone4}=I_{L}(π)×w48+I_{L}(3π/4)×(1−w48)

I_{L,Zone5}=I_{L}(π)×w15+I_{L}(−3π/4)×(1−w15)

I_{L,Zone6}=I_{L}(−π/2)×w26+I_{L}(−3π/4)×(1−w26)

I_{L,Zone7}=I_{L}(−π/2)×w37+I_{L}(−π/4)×(1−w37)

I_{L,Zone8}=I_{L}(0)×w48+I_{L}(−π/4)×(1−w48)

When the pixel intensity indexes I_{H}, I_{M} and I_{L} are calculated for each of the pixels as described above, the following procedures are executed.

(a) The direction θ of the gradient is calculated.
(b) The Zone corresponding to θ is detected.
(c) A filter computation is performed by using a set of filters corresponding to the detected Zone. For example, if θ belongs to Zone 1, I_{H}(0) and I_{H}(π/4) are calculated by using the filters illustrated in FIG. 13. Similar calculations are performed for I_{M} and I_{L}.
(d) I_{H}, I_{M} and I_{L} are calculated on results of the computations of the set of filters obtained in the above described (c) and based on θ.

Next, the gradient indexes G_{H}, G_{M} and G_{L} are calculated for each of the pixels of the smoothed image. Similarly to the pixel intensity indexes I_{H}, I_{M} and I_{L}, the gradient indexes G_{H}, G_{M} and G_{L} depend on the direction of the gradient obtained with the above equation (3). Accordingly, an example of calculating the gradient indexes G_{H}, G_{M} and G_{L} of Zone 1 (0≦θ<π/4) is described in a similar manner to the pixel intensity indexes.

Initially, the following equations are defined for “θ=0”. “gradMag(i, j)” represents the magnitude of the gradient of the pixel positioned at the coordinates (i, j). “gradMag(i+1,j)” represents the magnitude of the gradient of the pixel positioned at the coordinates (i+1,j). The similar expressions are applied to other pixels.

G_{H}(0)=gradMag(i,j+1)

G_{M}(0)=gradMag(i,j)

G_{L}(0)=gradMag(i,j−1)

Similarly, the following equations are defined for “θ=π/4”.

G_{H}(π/4)=0.5×{gradMag(i+1,j)+gradMag(i,j+1)}

G_{M}(π/4)=gradMag(i,j)

G_{L}(π/4)=0.5×{gradMag(i,j−1)+gradMag(i−1,j)}

Here, the gradient indexes of Zone 1 are calculated with linear interpolation using the gradient indexes of “θ=0” and those of “θ=π/4”. Namely, the gradient indexes of Zone 1 are calculated with the following equations.

G_{H,Zone1}=G_{H}(0)×ω+G_{H}(π/4)×(1−ω)

G_{M,Zone1}=G_{M}(0)×ω+G_{M}(π/4)×(1−ω)=gradMag(i,j)

G_{L,Zone1}=G_{L}(0)×ω+G_{L}(π/4)×(1−ω)

ω=1−{4×θ(i,j)}/π

As described above, the gradient index G_{M} is always “gradMag(i, j)” and does not depend on the direction θ of the gradient. Namely, the gradient index G_{M} of each of the pixels is calculated using the above described equation (1) or (2) regardless of the direction θ of the gradient.

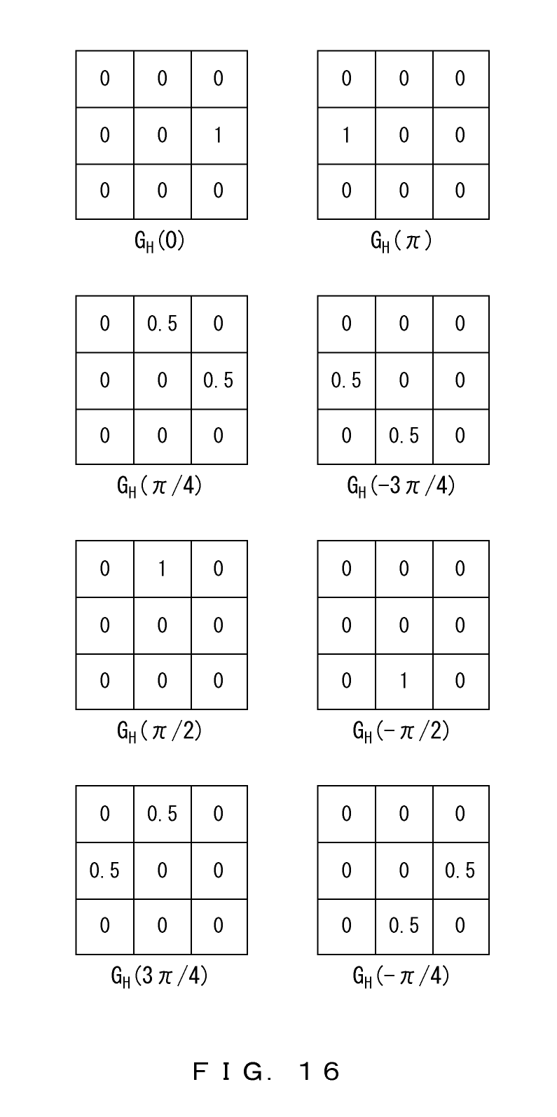

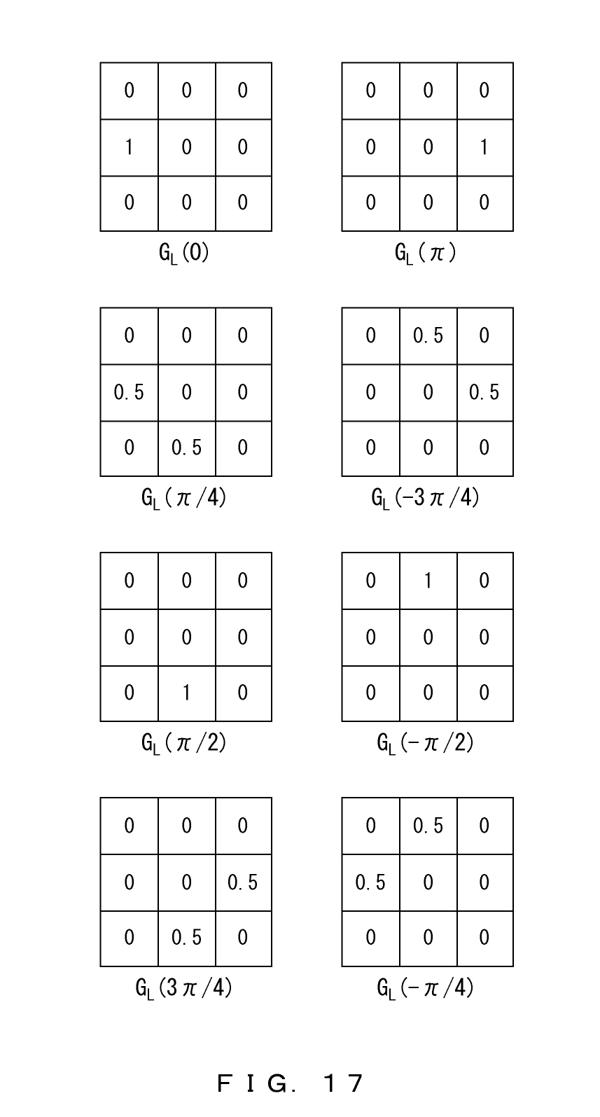

Also, the gradient indexes of Zone 2 to Zone 8 are calculated using similar procedures. Namely, the gradient indexes are respectively calculated for “θ=0, π/4, π/2, 3π/4. π, −3π/4, −π/2, and −π/4”. These gradient indexes are obtained by respectively performing the 3×3 filter computation for the magnitude gradMag of the gradient of each of the pixels of the smoothed image. FIGS. 16 and 17 illustrate configurations of filters for respectively obtaining the gradient indexes G_{H} and G_{L}.

By performing such filter computations, the gradient indexes G_{H} and G_{L} in the eight directions are obtained. The gradient indexes G_{H} of the Zones are respectively calculated with the following equations by using the gradient indexes G_{H} in two corresponding directions.

G_{H,Zone1}=G_{H}(0)×w15+G_{H}(π/4)×(1−w15)

G_{H,Zone2}=G_{H}(π/2)×w26+G_{H}(π/4)×(1−w26)

G_{H,Zone3}=G_{H}(π/2)×w37+G_{H}(3π/4)×(1−w37)

G_{H,Zone4}=G_{H}(π)×w48+G_{H}(3π/4)×(1−w48)

G_{H,Zone5}=G_{H}(π)×w15+G_{H}(−3π/4)×(1−w15)

G_{H,Zone6}=G_{H}(−π/2)×w26+G_{H}(−3π/4)×(1−w26)

G_{H,Zone7}=G_{H}(−π/2)×w37+G_{H}(−π/4)×(1−w37)

G_{H,Zone8}=G_{H}(0)×w48+G_{H}(−π/4)×(1−w48)

where w15, w26, w37 and w48 are respectively represented by the following equations.

W15=1−4θ/π

W26=4θ/π−1

W37=−1−4θ/π

W48=1+4θ/π

Similarly, the gradient indexes G_{L} of the Zones are respectively calculated with the following equations by using the gradient indexes G_{L} in two corresponding directions.

G_{L,Zone1}=G_{L}(0)×w15+G_{L}(π/4)×(1−w15)

G_{L,Zone2}=G_{L}(π/2)×w26+G_{L}(π/4)×(1−w26)

G_{L,Zone3}=G_{L}(π/2)×w37+G_{L}(3π/4)×(1−w37)

G_{L,Zone4}=G_{L}(π)×w48+G_{L}(3π/4)×(1−w48)

G_{L,Zone5}=G_{L}(π)×w15+G_{L}(−3π/4)×(1−w15)

G_{L,Zone6}=G_{L}(−π/2)×w26+G_{L}(−3π/4)×(1−w26)

G_{L,Zone7}=G_{L}(−π/2)×w37+G_{L}(−π/4)×(1−w37)

G_{L,Zone8}=G_{L}(0)×w48+G_{L}(−π/4)×(1−w48)

When the gradient indexes G_{H}, G_{M} and G_{L} are calculated for each of the pixels as described above, the following procedures are executed.

(a) The magnitude gradMag of the gradient is calculated.
(b) G_{M} is calculated based on gadMag.
(c) The direction θ of the gradient is calculated.
(d) A Zone corresponding to θ is detected.
(e) A filter computation is performed by using a set of filters corresponding to the detected Zone. For example, if θ belongs to Zone 1, G_{H}(0) and G_{H}(π/4) are calculated by using the filters illustrated in FIG. 16. G_{L} is calculated in similar way.
(f) G_{H} and G_{L} are calculated based on results of the computations of the set of filters obtained in the above described (e) and based on θ.

As described above, the evaluation indexes (the pixel intensity indexes I_{H}, I_{M} and I_{L} and the gradient indexes G_{H}, G_{M} and G_{L}) are calculated for each of the pixels of the smoothed image in step S24. These evaluation indexes are used to detect a blurred area, and to calculate the amount of a correction.

### Detection of a Blurred Area (Step S25)

The blurred area detection unit 32 checks, for each of the pixels of the smoothed image, whether or not the condition represented by the following equation (4) is satisfied. Equation (4) represents that a target pixel is positioned halfway of a brightness slope.

I_{H}>I_{M}>I_{L} (4)

A pixel having pixel intensity indexes that satisfy equation (4) is determined to belong to a blurred area (or determined to be positioned in an edge area). Namely, the pixel that satisfies equation (4) is determined to be corrected. In contrast, a pixel having pixel intensity indexes that do not satisfy equation (4) is determined to not belong to the blurred area. Namely, the pixel that does not satisfy equation (4) is determined not to be corrected. Pixels within the ramp area illustrated in FIG. 1 are probably determined to belong to the blurred area according to equation (4).

Extraction of a Pixel to be Corrected (Step S26)

The correction target extraction unit 33 extracts a pixel to be corrected from among pixels belonging to a blurred area. For instance, in the example illustrated in FIG. 6, pixels belonging to the area c or area d among pixels positioned in the edges are extracted. In the example illustrated in FIG. 7, only the pixels in the edges 2 and 4 among the pixels of the edges 1 to 4 are extracted. In the embodiment, a pixel having a gradient direction θ that belongs to Zone 3 or Zone 7 is extracted if the direction of a motion vector caused by a hand tremor belongs to Zone 3. The gradient direction θ is calculated with the above provided equation (3) for each of the pixels.

Then correction operations in steps S27 to S29 are performed for the extracted pixels. For pixels that are not extracted, the correction operations in steps S27 to S29 are not performed. Namely, when a pixel is determined not to be significantly affected by a hand tremor, the correction operations in steps S27 to S29 are not performed for the pixel, even if it is determined that the pixel is positioned in the edge in step S25. In other words, the blur correction circuit 30 may correct only a pixel in the edge that is significantly affected by a hand tremor.

Calculation of the Amount of a Correction (Steps S27 and S28)

The correction amount calculation unit 34 checks whether or not each pixel that is extracted as a correction target satisfies the following Cases 1 to 3.

Case1: G_{H}>G_{M}>G_{L}

Case2: G_{H}<G_{M}<G_{L}

Case3: G_{H}<G_{M} and G_{L}<G_{M}

Case 1 represents a situation in which the gradient of brightness becomes steeper. Accordingly, a pixel belonging to Case 1 is considered to belong to the area (area A) where the brightness level is lower than the central level in the ramp area of the edge illustrated in FIG. 1. In the meantime, Case 2 represents a situation in which the gradient of brightness becomes more moderate. Accordingly, a pixel belonging to Case 2 is considered to belong to the area (area B) where the brightness level is higher than the central level. Case 3 represents a situation in which the gradient of the target pixel is higher than those of adjacent pixels. Namely, a pixel belonging to Case 3 is considered to belong to an area (area C) where the brightness level is the central level or about the central level.

The correction amount calculation unit 34 calculates the amount of a correction for the brightness level of each pixel extracted as a correction target.

If a pixel belongs to Case 1 (namely, if the pixel is positioned in the low brightness area within the ramp area), the amount of a correction Leveldown of the brightness of the pixel is represented with the following equation. “S” is a correction factor, and “θ” is obtained with equation (3) described above.

$$If \frac{{G}_{H} - {G}_{M}}{{G}_{M} - {G}_{L}} \geq 0.5 Leveludown ( i , j ) = ( {I}_{m} - {I}_{L} ) \times S$$

$$else Leveldown ( i , j ) = ( {I}_{m} - {I}_{L} ) \times \frac{2 ( {G}_{H} - {G}_{M} )}{{G}_{M} - {G}_{L}} S$$

$$S = 1 - ( 1 - \sqrt{2} ) \frac{4 θ}{Π}$$

If a pixel belongs to Case 2 (namely, if the pixel is positioned in the high brightness area within the ramp area), the amount of a correction Levelup of the brightness of the pixel is represented with the following equation.

$$If \frac{{G}_{L} - {G}_{M}}{{G}_{M} - {G}_{H}} \geq 0.5 Levelup ( i , j ) = ( {I}_{H} - {I}_{M} ) \times S$$

$$else Levelup ( i , j ) = ( {I}_{H} - {I}_{M} ) \times \frac{2 ( {G}_{L} - {G}_{M} )}{{G}_{M} - {G}_{H}} S$$

If a pixel belongs to Case 3 (namely, if the pixel is positioned in the central area within the ramp area), the amount of a correction is zero. The amount of a correction is zero also if a pixel belongs to none of Cases 1 to 3.

Correction (Step S29)

The correction unit 35 corrects the pixel value (such as the brightness level) of each of the pixels of the original image (input image of the blur correction circuit 30). Here, pixel data “Image(i, j)” acquired with a correction performed for the pixel (i, j) is obtained with the following equation. “Original(i, j)” is pixel data of the pixel (i, j) of the original image.

Case 1: Image(i,j)=Original(i,j)−Leveldown(i,j)

Case 2: Image(i,j)=Original(i,j)+Levelup(i,j)

Other cases: Image(i,j)=Original(i,j)

As described above, the image correction apparatus 1 according to the embodiment calculates a motion vector that represents the direction and the magnitude of a hand tremor by using a plurality of images, and corrects only a pixel having a condition decided based on the motion vector. Namely, only a pixel on an edge, which is significantly affected by a hand tremor, is corrected. Accordingly, the amount of computation for the image correction is reduced while suitably correcting the hand tremor.

The image correction apparatus 1 according to the embodiment may perform contour enhancement instead of or along with the above described blur correction. The contour enhancement is performed by using a filter that corresponds to a direction of a motion vector calculated based on continuously-shot images. Namely, the contour enhancement is performed only in a blur direction represented by the direction of the motion vector.

The contour enhancement, not particularly limited, is implemented, for example, with an unsharp mask. The unsharp mask calculates a difference iDiffValue(i, j) between an original image and a smoothed image of the original image. This difference represents also a direction of a change. This difference is adjusted by using a coefficient iStrength, and the adjusted difference is added to the original image. As a result, a contour is enhanced.

A calculation of the unsharp mask is as follows. iStrength is a constant that represents the strength of the contour enhancement.

corrected value NewValue(i,j)=Original(i,j)+iDiffValue(i,j)×iStrength

As described above, with the image correction method according to the embodiment, the amount of computation for a hand tremor correction is reduced.

Additionally, with the image correction method according to the embodiment, a plurality of images the positional displacement of which has been corrected by using a calculated motion vector are synthesized, and a hand tremor correction may be performed for the synthesized image. In this case, noise is reduced compared with a method for performing a correction by using one image (or one of continuously-shot images). As a result, image quality is further improved.

Furthermore, with the image correction method according to the embodiment, image synthesis for areas where a subject is moving may be disabled. In this case, the subject is prevented from being multiplexed in the synthesized image.

Still further, with the image correction method according to the embodiment, image correction for an area where a subject is moving may be disabled. In this case, an unsuitable correction is prevented.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present inventions has (have) been described in detail, it should be understood that the various changes, substitutions, and alterations could be made hereto without departing from the spirit and scope of the invention.

What is claimed is:

1. An image correction apparatus, comprising:
a motion vector calculation unit to calculate a motion vector of an image based on a plurality of images sharing a shooting area;
a characteristic decision unit to decide an edge characteristic for image correction based on the motion vector calculated by the motion vector calculation unit; and
a correction unit to correct a pixel value of a pixel having the edge characteristic decided by the characteristic decision unit in an input image obtained from the plurality of images.

2. The image correction apparatus according to claim 1, wherein
the motion vector calculation unit calculates a motion vector by tracking a feature point with KLT transform.

3. The image correction apparatus according to claim 1, wherein
the characteristic decision unit decides, as the edge characteristic, a direction of a pixel value gradient for each pixel based on the motion vector.

4. The image correction apparatus according to claim 1, wherein
the correction unit performs a contour correction for sharpening an edge.

5. The image correction apparatus according to claim 1, wherein
the correction unit performs contour enhancement.

6. The image correction apparatus according to claim 1, wherein
the input image is one image selected from among the plurality of images.

7. The image correction apparatus according to claim 1, further comprising:
a position correction unit to correct a positional displacement among the plurality of images based on the motion vector; and
an image synthesis unit to generate a synthesized image by synthesizing the plurality of images the positional displacement of which has been corrected by the position correction unit, wherein
the correction unit corrects a pixel value of a pixel having the edge characteristic decided by the characteristic decision unit in the synthesized image.

8. The image correction apparatus according to claim 7, further comprising
a subject motion detection unit to detect a motion of a subject by using the plurality of images the positional displacement of which has been corrected by the position correction unit, wherein
the image synthesis unit synthesizes images of areas where a motion of a subject is not detected.

9. The image correction apparatus according to claim 1, further comprising
a subject motion detection unit to detect a motion of a subject, wherein
the correction unit does not correct a pixel within an area where a motion of a subject is detected.

10. An image correction apparatus, comprising:
a motion vector calculation unit to calculate a motion vector of an image based on a plurality of images sharing a shooting area;
an edge detection unit to detect an edge of an object or a texture in an input image obtained from the plurality of images;
a gradient direction detection unit to detect a pixel value gradient direction for each pixel positioned on the edge detected by the edge detection unit;
an extraction unit to extract a pixel having the pixel value gradient direction, which forms a predetermined angle with respect to a direction of the motion vector, from among pixels positioned on the edge; and
a correction unit to correct a pixel value of the pixel extracted by the extraction unit.

11. An image correction method, comprising:
calculating a motion vector of an image based on a plurality of image sharing a shooting area;
deciding an edge characteristic for image correction based on the calculated motion vector; and
correcting a pixel value of a pixel having the decided edge characteristic in an input image obtained from the plurality of images.

12. A recording medium on which is recorded an image correction program for causing a computer to execute an image correction method, the method comprising:
calculating a motion vector of an image based on a plurality of image sharing a shooting area;
deciding an edge characteristic for image correction based on the calculated motion vector; and
correcting a pixel value of a pixel having the decided edge characteristic in an input image obtained from the plurality of images.
